(19) United States
(12) Patent Application Publication
(10) Pub. No.: US 2014/0379526 A1
(43) Pub. Date: Dec. 25, 2014

(54) Electronic Shopping System for Retail Stores

(71) Applicant: Tristan Ryshunn Parham, Riverdale, IL (US)

(72) Inventor: Tristan Ryshunn Parham, Riverdale, IL (US)

(21) Appl. No.: 14/209,640

(22) Filed: Mar. 13, 2014

Related U.S. Application Data
(60) Provisional application No. 61/787,325, filed on Mar. 15, 2013.

(51) Int. Cl. G06Q 30/06; G06F 17/30

(52) U.S. Cl. CPC G06Q 30/0613; G06Q 30/0633; G06Q 30/0641; G06F 17/30528; G06Q 30/0639
USPC 705/26.41

(57) ABSTRACT

A method and system to assist and guide a customer during a shopping experience in a “brick and mortar” type store in order to provide a more pleasant, effective, and efficient shopping environment is provided. Such a method and system allows a customer to more easily locate and access specific desired items in, for example, a large retail store. The customer can also more easily compare similar items, determine if the desired item or similar items are on sale, whether such items are in stock, issue rain checks on sale items out of stock, assess detailed information on such items, and keep a running account of the costs of the items selected. Such a method and system also provides significant benefits to the retailer, including, for example, increased customer satisfaction, direct communication and interaction with the customer, as well as better inventory control and reduced operating costs.

### RELATED APPLICATION

This application is based on, and claims benefit of, U.S. Provisional Application 61/787,325 filed on Mar. 15, 2013, which is hereby incorporated by reference.

### FIELD OF THE INVENTION

This invention relates to a method and system to assist and guide a customer during a shopping experience in a “brick and mortar” type store in order to provide a more pleasant, effective, and efficient shopping environment. Such a method and system allows a customer to more easily locate and access specific desired items in, for example, a large retail store. The customer can also more easily compare similar items, determine if the desired item or similar items are on sale, whether such items are in stock, issue rain checks on sale items out of stock, assess detailed information on such items, and keep a running account of the costs of the items selected. Such a method and system also provides significant benefits to the retailer, including, for example, increased customer satisfaction, direct communication and interaction with the customer, as well as better inventory control and reduced operating costs.

### BACKGROUND OF THE INVENTION

Large box type retail outlets are becoming more and more prevalent, especially in larger urban areas, in the retail environment. For the shopper, they offer potential cost savings and reduction in the number of stores that must be visited to satisfy consumer need and demand. And for the retailer, such large box type retail outlets offer significant advantages including, for example, scale, fewer retail locations, fewer employees, and the ability to attract a wide variety of shoppers.

Shopping, especially in an unfamiliar and large retail outlet containing a wide variety of items, can be a daunting task for even the most experienced shopper. Simply locating a specific desired item or items can be challenging. And collecting the various items on one's shopping list—once they are located—throughout the retail store can be an exhausting task. As the number of seniors in the population increases, these problems will become even more significant. Indeed, significant percentages of the population may avoid such large retail outlets—in spite of the potential cost savings such stores provide—simply due to the problems associated with the scale of the retail outlet. Thus, merely anticipating such problems will likely prevent some shoppers, perhaps even a significant number, from visiting such retail outlets.

On line shopping solutions are currently available to assist consumers. For example, Peapod® allows consumers to order groceries on line for later delivery to the consumer's location. Although such systems are convenient—especially for non-perishable items—there are a number of drawbacks. For example, a consumer is not able to specifically select fresh vegetables, fruits, or meat products based on their own preferences or quality criteria. Although general criteria for selection of such items can be provided (e.g., prefer more or less ripe fruit), the ability to specifically determine if the quality is acceptable to the specific consumer is not available. Nor can consumers easily select suitable alternatives should a specific item desired be out of stock (e.g., a specific brand item or other product). Failure of the service provider to provide an item at all or supplying an inappropriate alternative can lead to consumer dissatisfaction. The inability of the consumer to personally observe (see, smell, or even taste) the product or similar products (especially food products) is a significant drawback for many consumers. For some, if not many consumers, such disadvantages will significantly reduce the convenience of such services, even to the point where they will discontinue the service entirely.

It is desired, therefor, to provide methods and systems to reduce the problems associated with, or even considered likely to be encountered when, utilizing such large retail operations and/or on-line shopping services. The present invention provides such methods and systems.

### SUMMARY OF THE INVENTION

This invention relates to a method and system to assist and guide a customer during a shopping experience in a “brick and mortar” type store in order to provide a more pleasant, effective, and efficient shopping environment. Such a system, which is especially adapted for larger retail spaces containing multiple type product lines (e.g., big box stores, department stores, grocery stores, and the like), can easily be incorporated into existing or newly constructed retail stores. The present method and system can be used in single floor or multiple floor retail stores.

Such a method and system allows a customer to more easily locate and access specific areas (e.g., fresh produce, fresh fruit, and the like) specific desired items (e.g., locally grown tomatoes, specific types of apples, and the like) in, for example, a large retail store. The location data should direct the consumer directly to the product's actual location (i.e, appropriate aisle, appropriate location within the aisle, and appropriate shelf at that location). Thus, the consumer is not merely directed to the aisle where the product is located and then left to his or her devices to determine the actual location along and within the aisle as often happens when a consumer asks direction in a conventional retail environment (e.g., “it is somewhere in aisle 9”—and good luck finding its specific location in aisle 9).

The customer can also more easily compare similar items, determine if the desired item or similar items are on sale, whether such items are in stock, issue rain checks on sale items which are out of stock, assess detailed information on such items, and keep a running account of the costs of the items selected for purchase. Such a method and system also provides significant benefits to the retailer, including, for example, increased customer satisfaction, direct communication and interaction with the customer, possible reduction in number of employees, as well as better inventory control and reduced operating costs.

The system uses individual data communication devices which allow a customer to access data regarding items which are offered for sale by the store; such data could include, for example, location of departments or specific items of interest to the customer within a store, physical directions to such departments or items, informational and product type data regarding the specific items, as well as similar items, to allow the customer to make more informed decisions, and the like. The individual data communication devices (operated by individual consumers) are in electronic communication with computer systems controlled and operated by the store; the computer system provides, upon request by the consumer through the individual data communication devices, information regarding the store as well as items offered for by sale within the store. The system may utilize GPS-type devices and/or technology to assist in providing the location as well as directions to that location for specific items desired by the customer or consumer.

Individual data communication devices can include, for example, hand-held devices, shopping cart mounted devices, fixed position devices (e.g., information kiosks), and the like. Preferably the customer interacts with the individual data communication device via a touch screen which displays options available to a given customer. By inputting identifying information relative to the desired item or items, the consumer effectively requests and obtains electronic assistance, thereby avoiding seeking out an employee (who may or not be available and/or who may or may not have the desired knowledge) to provide immediate assistance. Even if a given employee has an intimate understanding of one or more of the store's main sections (e.g., grocery, hardware, automotive, and/or the like) or even of the entire store's inventory, that employee may not be immediately available (especially where multiple customers are seeking assistance) or, even if available, may not have the desired information a given customer seeks (e.g., if a specific item is in stock and/or on sale, comparison of similar items, and the like—especially if that employee is new and/or is assigned to other departments within the store). Using the electronic shopping system of the present invention, a customer can have almost immediate access to such information, as well much other desired information, which can significantly enhance the shopping experience. Moreover, significant numbers of customers can access individualized information tailored to their specific needs and desires in real time without direct assistance by store employees. Thus, store employees may attend to other tasks or assist customers who, for whatever reason, do not wish to employ the electronic shopping system or method.

### BRIEF DESCRIPTION OF THE DRAWINGS

FIG. 1 illustrates general relationships between the basic system components making up an embodiment of the present invention.

FIG. 2 provides a general flow diagram illustrating one embodiment of the present invention.

FIG. 3 provides a general flow diagram illustrating possible interactions between shopper and retail store via electronic information.

FIG. 4 illustrates an array of location-determining devices in combination with an individual data communication device in a retail store environment.

### DETAILED DESCRIPTION OF THE INVENTION

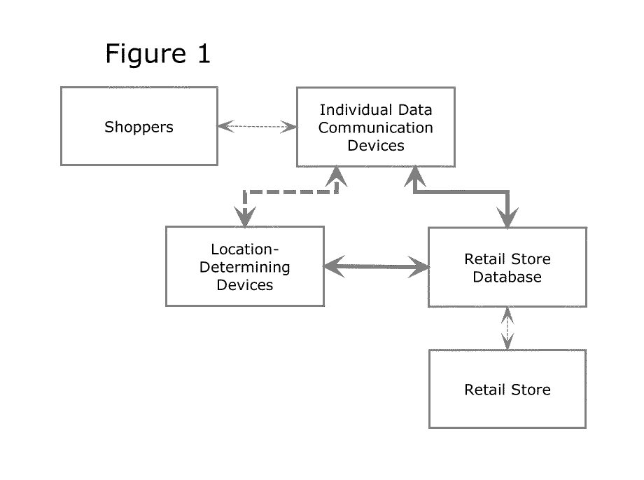

The basic system components of the present invention are shown in FIG. 1. The basic system component in include (1) individual communication devices, (2) location-determining system, and (3) the retail store's database. The shopper interacts with the system using the individual communication devices which allows access to the database and the location-determining devices. Generally, it will be preferred that individual communication devices interact and communicate with the location-determining devices through the database. In some cases, it may be advantageous for direct communication between the individual communication device and the location-determining system (as shown by the heavy dashed line). For example, if a shopper only wishes to determine the location of a few items, such direct communication between the individual communication device and the location-determining system may be more convenient.

The shopper interacts and communicates with the electronic shopping system via his or her individual communication device in order to determine product location and/or access other information provided in the database by the retail store. And the retail store interacts and communicates with the shopper via the database and the specific shopper's individual communication device. Thus, two-way communication between the shopper and the retail store can be established. Using the database, the retail store can provide (upon the shopper request) information on various products available for sale. This, allows a customer to more easily locate and access specific desired items in, for example, a large retail store. The customer can also more easily compare similar items, determine if the desired item or similar items are on sale, whether such items are in stock, issue rain checks on sale items out of stock, assess detailed information on such items, and keep a running account of the costs of the items selected. Such a method and system also provides significant benefits to the retailer, including, for example, increased customer satisfaction, direct communication and interaction with the customer, as well as better inventory control and reduced operating costs. The retail store can tailor available information to specific shopper thereby make the shopping experience more efficient, easier, and satisfying as well as saving the shopper time and money. Such a satisfied and informed shopper is more likely to repeatedly return to the retail store.

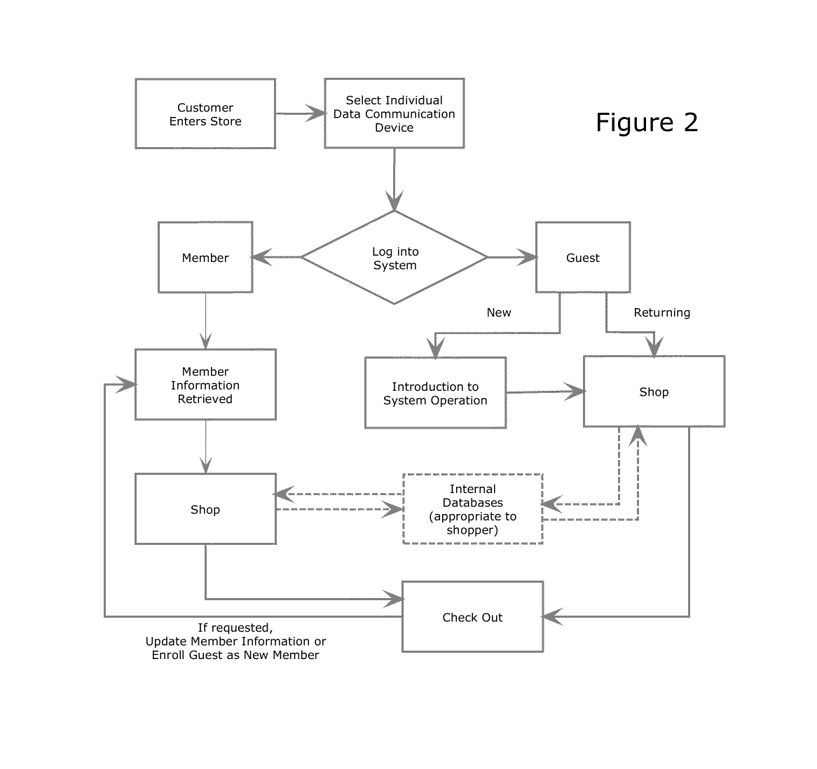

As shown in FIG. 2, a shopper entering the store initially selects the desired type of individual data communication device to be used during the shopping activity. Such devices can include, for example, hand-held devices, shopping cart mounted devices, fixed position devices (e.g., information kiosks), and the like. The shopper then effectively logs into the store's shopping database using the communication device. The store's database system may, if desired, include options for logging in as members, guests, or other types of participants.

Depending on the log-in option, access to various portions of the retailer's database may be available to the shopper. General portions of the database available to all shoppers would include product locations, information regarding products (e.g., prices, sizes available, brand name and/or store brand products available), comparison of similar products as well as items on sale, special promotions, and the like.

This general database could also include information regarding a given product's current availability. For items which are currently out-of-stock, information regarding comparable products that are in-stock, availability in nearby stores of the retail chain, or availability on-line could be provided. For out-of-stock items on sale, electronic rain checks could be provided immediately in a printed form or sent via email to the consumer's email address upon request. Preferably, the consumer could request an indication of when the item is expected to be available and/or notification (e.g., via email) of the actual restocking of the item. Such notifications provide the retailer additional opportunities to interact with the consumer and to build a stronger, more positive, and long-lasting relationship.

Options may also be personally tailored to the specific shopper. For example, the shopper may be able to access a shopping list based on his or her last visit to the store. Or, the shopper may be able to access a shopping list previously entered on-line or through a smart-phone or other device prior to the specific visit. Alternatively, the retailer may provide the shopper with a suggested and personalized stopping list based on the consumer's supplied preferences and/or previous shopping trips; of course, the consumer's consent to the retailer retaining and using personal data to generate such lists would be required. Such data would also provide the retailer the ability to provide tailor-made coupon opportunities for an individual consumer based on their actual shopping activities. Or to provide timely notifications of specials, sales, and/or compounds on actual products that the consumer has purchased in the past.

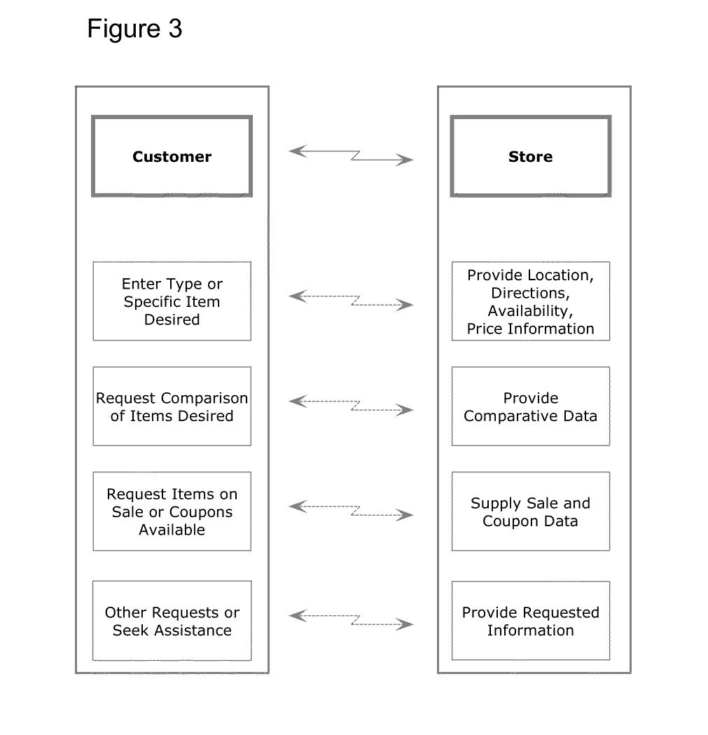

As shown in FIG. 3, the customer can interact directly with the retail store (and its database) to request information and guidance with regard to the specific shopping experience. Thus, for example, the shopper can request information regarding a specific and desired product. The database responds directly to the individual data communication device with information regarding the location of the product, directions to the product location, price, availability, and the like. If appropriate, information regarding the product's on sale status (or other promotions involving the product) can be provided; information regarding similar and comparable products which might be on sale could also be provided. Should the product be out of stock, that fact should be transmitted to the consumer. As appropriate, the consumer could be advised regarding the product's expected availability and/or the availability of a rain check if the product is on sale and/or comparable products which are in stock.

The consumer could, if desired, ask for additional information that might be available for a desired product; such additional information could include different sizes available as well as cost/unit weight or volume data for the various sizes and the like. The location data returned to the consumer should include both the aisle where the product is located and its location with in the aisle (i.e., coordinates to define its location along the length of the aisle, the specific side of aisle, and vertical location on a specific shelf). The directions provided should direct the consumer directly to the product location within the aisle and provide the detailed location information on the shelf. The directions should be updated as the consumer moves to the product location to take into account deviations by the consumer from the directions (whether such deviations are intentional or unintentional). Thus, a consumer may investigate other products or promotions observed along the route and still arrive at the desired location without further input on their part.

As also shown in FIG. 3, the consumer may also request comparative data relative to a given desired product. Such comparative data may include comparison of various sizes of the specific product and/or comparison of similar products (e.g., various store or brand-named products). Such data should, of course, allow for direct comparison of the products desired. Thus, for example, if brand A and brand B of a given product are only available in different sized versions, that fact should be clearly indicated and price comparisons should be given in cost per unit of the two products.

The consumer may also ask for sale or coupon data in order to better inform his or her shopping experience. Such a request may be made at any time during the shopping experience. The retail store may offer, in combination with various manufacturers, immediate and electronic access to currently available coupons, rebate forms, and other promotional information for use in the current shopping experience. Such coupons or forms may be printed out at a kiosk within the store or at the check out counter. In such cases, the consumer can take advantage of coupons he or she brings to the store as well as coupons generated at the store. A consumer who knows that such coupons may be available within the store will, of course, more likely return to the store in the future.

As also shown in FIG. 3, the consumer may also request additional information related to the shopping experience. The amount and content of such additional information will depend, of course, on the retail outlet. Thus, for example, recipes could be electronically available where the consumer, upon request, could be provided with a list of necessary ingredients (along with their locations within the store) and a print out of cooking directions; alternatively, and upon request, such information could be sent to a supplied email address. Meal suggestions could also be provided; these could be based on the type of meal desired (e.g., vegetarian, ethnic, or many other types) and the number of persons to be served.

In additions to the above requests, the consumer could request personal assistance. For example, once the consumer arrives at the desired product location, assistance reaching the actual product may be required or additional questions may be asked. Or if product is not located on the shelf, the consumer can request that it be restocked (assuming it remains in stock within the store). Or a specific question or request not addressed via individual data communication device can be handled.

The system can, if desired, be used to better inform the consumer of sale events. For example, if a consumer selects and scans an item on sale, the system could inform the consumer of the sale (and the amount saved) and suggest that the consumer might want to stock up on the item. For another example, when a consumer selects and scans one item for which a “buy one get one free” sale is in effect (and which requires actual purchase of two items), the system could inform the consumer of the sale and indicate that the additional item is available for free. If such a “buy one get one free” sale allows the purchase of a single item for half price, the system could also so inform the consumer. The system could, if the appropriate items are selected and scanned, inform the shopper of conditions placed on more other sale offers (e.g., “buy three and get 2 free” or “10 for $10”). Thus, the system can be used to provide information to the consumer regarding potentially confusing sale events and the specific conditions required by the specific sale events. If desired, the system could provide specific manufacturer coupons for appropriate items scanned into the consumer's shopping cart. By assisting the consumer obtain the maximum savings possible, the retail outlet can increase consumer loyalty.

The information available is not, of course, limited by that listed in FIG. 3. Additional information can be made available as desired by the retail operator by providing additional options via individual data communication device by appropriate software. Indeed, followup data from consumers may uncover improvements in both the present service provided as well as entirely new services that could be provided.

As noted above, additional options may be available, and preferably are available, for returning customers. To access such options, such returning consumer may be required to log into the into system. Thus suggestions or even automatically generated shopping lists may be available to such customers based on their previous shopping experiences. Additional cost savings—including coupons, discounts, or other promotions not available to the general public—may be offered to such returning shoppers. Such returning may also have the option of inputting their own shopping lists via the internet prior to arriving at the retail store or once they arrive via, for example, an application store on their smart phone. Directions to product locations could be generated, if desired, such that refrigerated and frozen items are listed at the end and thus only selected after the remainder of the items (i.e., non-perishable) on the shipping list has been collected

Indeed, if the retailer wished to offer such a service, non-perishable and standard items on the consumer's shopping list could be collected prior to the consumer's arrival. The consumer would then be only required to physically select items such as fresh fruit or vegetables, fresh meat products, and the like or make decisions regarding alternative items in case some products are out of stock. Using such a system, the individual consumer only would need to select products where personal selection criteria are most important.

Product location and direction data can generated upon request using the individual data communication device. In a preferred embodiment, the individual data communication device is in two-way electronic communication with various location-determining devices placed at specific locations within the retail store. By transmitting electronic signals to such location-determining devices, the individual communication device in effect relays its location data to the software system, which in turn relays direction information, based on the consumer's input request, to allow the consumer to locate and travel to one or product locations indicated in the input request. The signal output from the individual data communication device can be logged at sufficient location-determining devices to determine the location of the specific individual data communication device. Thus, for example, the location-determining device or devices can consist of gps units or non-gps receiving stations located a fixed positions within the retail outlet. For gps receiving units, standard gps procedures may be used. For non-gps receiving stations, the location of the individual data communication device can be determined, for example, using triangulation techniques or other calculation methods. By periodically repeating such measurements, the consumer can be tracked through out the retail store; thus, the directions to a given product can be updated as needed should the consumer, intentionally or unintentionally, deviate from the directions initially given.

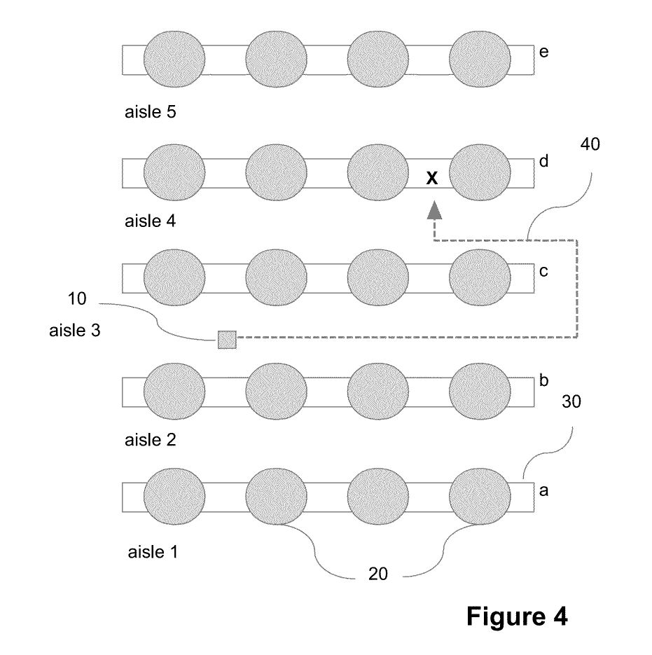

FIG. 4 illustrates an array of location-determining devices or nodes 20 in combination with an individual data communication device 10 in a retail store environment containing shelves 30 (labeled a through e) containing products. The individual data communication device 10 is electronic communication with the various location-determining devices 20 which allows the location of the of the individual data communication device to be determined. Once the shopper enters the desired product (shown as X in FIG. 4) on the individual data communication, the inputted data is sent electronically to the software system (not shown) installed in the store computer. Using the product information stored on the computer system and the shopper's current location determined through the location-determining device, the software can determine appropriate directions or pathway (shown by the dashed line 40) for the shopper to be able to travel directly to the desired product; the directions back are sent back to the particular individual data communication device 10 assigned to that particular shopper. In Figure, the shopper 10 is directed down aisle 3 between shelves b and c, instructed to turn left and then left again down aisle 4. The shopper 10 is then directed down aisle 4 to location X on shelve d; the shopper 10 is also provided with the vertical location (not shown) on shelve d where the desired product is physically located. In this manner, the shopper is able to move directly to the desired product without any further assistance.

As the shopper moves along the directed pathway, the shopper's location is continuously updated using the array of location-determining devices or nodes 20; should the shopper proceed correctly along the directed pathway, no further intervention is needed. If however, the shopper deviates from the directed pathway (e.g., by investigating a product noticed away from the directed pathway), the system can inform the shopper and, if the shopper desired, provide a new directed pathway to the desired product. Of course, the shopper may, if desired, cancel his or her request for the initially desired product or simply postpone it for later. In such cases, the system may later prompt the shopper regarding the cancelled or postpone items in case the shopper desires such items and has simply forgotten about their cancellation or postponement. The shopper should be able to override or even turn off such prompting features if desired.

Once the shopper reaches the desired product and makes his or her selection, the desired product is placed in the shopping cart. Along with the individual data communication device, a scanner can be mounted on the shopping cart (or incorporated into the individual data communication device) to allow the shopper, if he or she so desired, to scan the selected products in order, for example, to keep track of the items selected as well as their prices. Thus, the shopper may, if desired, keep a running dollar total and list of the items selected. If items located in the shopping cart are removed therefrom, the items may be re-scanned so as to remove them from the total running list of items selected; alternatively, may manually remove such de-selected items from the total running list. If the shopper has initially inputted a shopping list, the scanned items in the shopping cart can be so indicated on the stored shopping list thus allowing the shopper to see at a glance which items on the shopping list remain to be found. Differences between the scanned prices and prices listed on the shelves and/or advertised prices can easily be determined so that they can more easily be corrected. Preferably, the system will allow the shopper to highlight items where such differences occur so that they can be addressed as the check out counter. Coupons, rain checks from previous visits, and the like can also be scanned so that the total running cost may more accurately be maintained.

Once the shopper completes his or her shopping, the shopper may proceed to check out. If the automated running total has been generated during the shopping trip, this generated total may be compared against the check out total so that any discrepancies can be resolved immediately. Indeed, the automated running list can be downloaded from the individual data communication device for direct comparison with the check out listing thereby showing the specific items for which any discrepancies arise. By identifying such specific items, such discrepancies should be more easily resolved. Conformation of correct pricing and the like will increase shopper satisfaction, will tend to improve the retail store's reputation (both for the specific shopper as well as for the shopper's friends or others who learn of the shopper's positive experience), and will likely result in further visits by the shopper and others impressed by positive experience.

Indeed, for both privacy and personal considerations, the shopper should be able to control the features available to him or her during the shopping experience. This should include the ability to turn such features off or on as desired. Help and assistance should be available to the shopper as needed; but the shopper should be able to control the system as with regard to amount of interaction between the shopper and the system. Such control will increase the satisfaction of the shopper over a wide range of individual shoppers, each with their own personal considerations.

The system may also be used by the retailer to control inventory and carry out other administrative tasks. Thus, for example, a running inventory control system can be implemented whereby the retailer can more readily be informed which products need to restocked. The system can also be used by the retailer to follow shopping trends and more readily identify and supply shoppers with products options, display options, product locations, and the like meeting their preferences. The product location system can be used by the retailer to more easily restock shelves, replace misplaced items, and the like using less experienced employees. It takes considerable time and training for employees to be able to easily and quickly identify and locate product locations; the system could be used by less experienced employees to determine product locations for restocking activities or in responding to customer's verbal requests on the retail floor. And by having such a system whereby product location can easily be determined by both shoppers and employees, the retailer can more easily modify product locations within the store as needed and/or desired without significantly inconveniencing or turning off shoppers who have become familiar with the store.

1. An electronic shopping system for a retail store containing individual products offered for sale, said system comprising
(1) an individual data communication device for each shopper who desires to use the system, wherein each individual shopper's individual data communication device is assigned an unique identifier during a shopping experience;
(2) sufficient location-determining devices arranged throughout the retail store whereby the location of each uniquely identified individual data communication device and the location of products offered by the retail store can be determined; and
(3) a database containing individual product's locations within the retail store and information regarding the individual products,
wherein the uniquely identified individual data communication device is in electronic communication with (a) the location-determining devices to allow the location of the uniquely identified individual data communication device within the retail store to be determined on an essentially continuous manner and (b) the database,
wherein the uniquely identified individual data communication device is in electronic communication with the database,
wherein the uniquely identified individual data communication device has an input and output capabilities to allow the individual shopper to communicate with, and receive data from, the database with regard to the individual shopper's location relative to individual products selected by the individual shopper and directions to the selected individual products,
whereby the individual shopper can request information from the database regarding selected individual products and can receive requested information from the database, and
whereby the individual shopper is guided to the location of the selected individual products within the retail store via specific directions from uniquely identified individual data communication device's current location to the location of the selected individual products.

2. The system as defined in claim 1, wherein the individual data communication device is mounted on a shopping cart used by the individual shopper.

3. The system as defined in claim 2, wherein the individual shopper's shopping cart is equipped with a scanner so that individual products selected by the individual shopper can be scanned as they are placed in the individual shopper's shopping cart.

4. The system as defined in claim 1, wherein the location-determining devices are gps units.

5. The system as defined in claim 2, wherein the location-determining devices are gps units.

6. The system as defined in claim 1, wherein the database, upon request for one or more individual product locations, returns a map to the individual shopper's individual data communication device, wherein the map illustrates the individual product locations and guides the individual shopper to the individual products.

7. The system as defined in claim 5, wherein the database, upon request of one or more individual product locations by the individual shopper, returns a map to the individual shopper's individual data communication device, wherein the map illustrates the individual product locations and guides the individual shopper to the individual products.

8. The system as defined in claim 1, wherein the retail store is a grocery store.

9. The system as defined in claim 7, wherein the retail store is a grocery store.

10. An electronic shopping system for a retail store containing individual products offered for sale, said system comprising
(1) an individual data communication device for each shopper who desires to use the system, wherein each individual shopper's individual data communication device is assigned an unique identifier during a shopping experience, wherein the individual data communication device is mounted on a shopping cart used by the individual shopper, and wherein the shopping cart is equipped with a scanner so that individual products selected by the individual shopper can be scanned as they are placed in the individual shopper's shopping cart;
(2) sufficient location-determining devices arranged throughout the retail store whereby the location of each uniquely identified individual data communication device and the location of products offered by the retail store can be determined; and
(3) a database containing individual product's locations within the retail store and information regarding the individual products,
wherein the uniquely identified individual data communication device is in electronic communication with (a) the location-determining devices to allow the location of the uniquely identified individual data communication device within the retail store to be determined on an essentially continuous manner and (b) the database,
wherein the uniquely identified individual data communication device is in electronic communication with the database,
wherein the uniquely identified individual data communication device has an input and output capabilities to allow the individual shopper to communicate with, and receive data from, the database with regard to the individual shopper's location relative to individual products selected by the individual shopper and directions to the selected individual products,
whereby the individual shopper can request information from the database regarding selected individual products and can receive requested information from the database, and
whereby the individual shopper is guided to the location of the selected individual products within the retail store via specific directions from uniquely identified individual data communication device's current location to the location of the selected individual products.

11. The system as defined in claim 10, wherein the location-determining devices are gps units and wherein the database, upon request for one or more individual product locations, returns a map to the individual shopper's individual data communication device, wherein the map illustrates the individual product locations and guides the individual shopper to the individual products.

12. The system as defined in claim 10, wherein the retail store is a grocery store.

13. The system as defined in claim 11, wherein the retail store is a grocery store.
